(19) United States
(12) Patent Application Publication
(10) Pub. No.: US 2006/0088674 A1
(43) Pub. Date: Apr. 27, 2006

(54) Ultraviolet curable barrier layers

(76) Inventors: Molly L. Hladik, San Diego, CA (US); Silke Courtenay, Temecula, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/070,606

(22) Filed: Mar. 2, 2005

Related U.S. Application Data
(60) Provisional application No. 60/622,869, filed on Oct. 27, 2004.

(51) Int. Cl. B41M 5/40

(52) U.S. Cl. 428/32.34

(57) ABSTRACT

An ultraviolet-curable coating formulation that consists essentially of at least one multifunctional monomer and a photoinitiator.

### CROSS REFERENCE TO RELATED APPLICATION

This application claims the benefit of U.S. provisional patent application Ser. No. 60/622,869, filed Oct. 27, 2004.

### FIELD OF THE INVENTION

The present invention relates to an ultraviolet (“UV”) curable barrier layer. More specifically, the present invention relates to a UV curable barrier layer formed from a coating formulation that includes a multifunctional monomer and a photoinitiator.

### BACKGROUND OF THE INVENTION

With the recent rise in digital photography, the desire to generate printed images having photographic quality is increasing. To meet this need, research has been ongoing to develop inexpensive print media that provide photographic quality images. The print media currently developed for this purpose have a layer of polyethylene extruded on both surfaces of a substrate or support layer. The polyethylene-coated substrate is coated with an ink-receiving layer, upon which the image is printed. When the image is printed on the print medium with an inkjet ink, the polyethylene coating prevents water in the inkjet ink from diffusing into the substrate. Without the polyethylene coating, the water in the inkjet ink would penetrate the substrate, causing the substrate to unevenly cockle, which negatively affects gloss and smoothness of the printed image. However, extruding the polyethylene onto the substrate is expensive and, therefore, these print media are expensive to fabricate.

Water-based barrier layers have also been developed to coat the substrate. However, after applying the water-based barrier layer to the substrate, the coating must be dried, which adds additional steps to the overall fabrication of the print media. Furthermore, the water-based barrier layers do not provide a sufficiently glossy coating to the print medium.

Barrier layers that are formed from ultraviolet-curable coatings are also known. Coating formulations of these barrier layers include various combinations of oligomers, difunctional monomers, and tetrafunctional monomers, such as acrylates, methacrylates, vinyl ethers, and acrylamides. Some of the coating formulations also include pigments. The coating formulation is cured with UV radiation to form the barrier layer.

### BRIEF SUMMARY OF THE INVENTION

The present invention relates to an ultraviolet-curable coating formulation that includes at least one multifunctional monomer and a photoinitiator. The present invention also relates to a print medium for use in inkjet printing. The print medium includes a substrate, a barrier layer formed from a coating formulation that consists essentially of at least one multifunctional monomer and a photoinitiator, and an ink-receiving layer. The present invention also relates to a method of forming a print medium.

### BRIEF DESCRIPTION OF THE SEVERAL VIEWS OF THE DRAWINGS

While the specification concludes with claims particularly pointing out and distinctly claiming that which is regarded as the present invention, the present invention can be more readily ascertained from the following description of the invention when read in conjunction with the accompanying drawings in which:

FIG. 1 is a schematic illustration of one embodiment of a print medium of the present invention.

### DETAILED DESCRIPTION OF THE INVENTION

A barrier layer for use in a print medium is disclosed. The barrier layer is formed from a coating formulation that includes a difunctional or higher (i.e., difunctional, trifunctional, tetrafunctional, pentafunctional, hexafunctional, or higher) monomer and a photoinitiator. As used herein, the term “coating formulation” refers to a pre-cure mixture of ingredients or components that is formulated to produce the barrier layer after curing. The coating formulation may be cured by exposure to UV radiation to form the barrier layer. As used herein, the term “difunctional” refers to a monomer having two double bonds between carbon-carbon atoms in the monomer. Similarly, the terms “trifunctional,” “tetrafunctional,” “pentafunctional,” and “hexafunctional” describe monomers having three, four, five, and six double bonds, respectively, between carbon-carbon atoms in the monomer. The term “monomer” is used to refer to an organic compound having no more than one repeat unit. For the sake of simplicity, the monomer is referred to herein as a “multifunctional monomer.” Therefore, as used herein, the term “multifunctional monomer” refers to a monomer having at least two carbon-carbon double bonds and having up to and including 6 carbon-carbon double bonds. The coating formulation may also include a mixture of the multifunctional monomers.

The multifunctional monomer may be an organic compound having a molecular weight ranging from at least approximately 150 to approximately 2,000. Multifunctional monomers that fall within this molecular weight range may provide sufficient flexibility to the barrier layer without causing the barrier layer to be tacky or sticky. The multifunctional monomer may be a liquid at room temperature (approximately 25° C.). The multifunctional monomer may be present in the coating formulation from approximately 80% by weight (“wt %”) to approximately 99.9 wt %. For the sake of example only, if the coating formulation includes the multifunctional monomer and the photoinitiator, the multifunctional monomer may be present from approximately 90 wt % to approximately 99.9 wt %. If the coating formulation includes the multifunctional monomer, the photoinitiator, and an optional oligomer (as discussed below), the multifunctional monomer may be present in the coating formulation from approximately 80 wt % to approximately 99.9 wt %.

The multifunctional monomer may be a urethane monomer, a polyester monomer, an acrylate monomer, a polyester acrylate monomer, a polyether monomer, an acrylic ester monomer, a vinyl ether monomer, a urethane acrylate, a polyepoxide monomer, an N-vinyl pyrrolidone monomer, a caprolactam monomer, or mixtures thereof. Specific examples of acrylates include, but are not limited to, dipropylene glycol diacrylate (“DPGDA”), 1,6-hexanediol diacrylate (“HDDA”), ethoxylated hydroxydioxanediacrylate (“HDODA”), tripropylene glycol diacrylate (“TRPGDA”), polyethylene glycol diacrylate, a triethylene glycol diacrylate (“TEGDA”), a bisphenol-A derivative diacrylate monomer, an acrylated di-pentaerythritol (“DPHPA”), a propoxylated glycol triacrylate (“G3POTA”), pentaerythritol triacrylate (“PETA”), trimethylolpropane ethoxy triacrylate (“TMPEOTA”), trimethylolpropane triacrylate (“TMPTA”), tetraethylene glycol dimethacrylate-4-ethylene glycol (“TTEGDMA”), trimethylolpropane trimethacrylate (“TMPTMA”), octyl/decyl acrylate (“ODA”), isobornyl acrylate (“IBOA”), and mixtures thereof. Many of these acrylates are commercially available, such as from Surface Specialties (a business of UCB S.A. (Brussels, Belgium)). In one embodiment, the multifunctional monomer is at least one acrylate monomer.

The vinyl ether may be a divinyl ether, a difunctional aliphatic vinyl ether, an aliphatic urethane divinyl ether, a trifunctional aromatic vinyl ether, or mixtures thereof. Examples of the vinyl ether include, but are not limited to, 4-hydroxybutylvinyl ether, triethyleneglycol divinyl ether, cyclohexane dimethanolvinyl ether, bis-(4-vinyloxybutyl)isophthalate, bis [[[4-(ethenyloxy) methyl]cyclohexyl]methyl]terephthalate, bis-(4-vinyloxybutyl)adipate, bis-(4-vinyloxybutyl)hexamethylenediurethane, tris(4-vinyloxybutyl)trimellitate, and mixtures thereof. In one embodiment, the multifunctional monomer is at least one vinyl ether monomer. In another embodiment, the multifunctional monomer is a mixture of at least one acrylate monomer and at least one vinyl ether monomer.

Multifunctional monomers having these properties are commercially available, such as under the VEctomer® or Rapi-Cure® tradenames. The VEctomer® multifunctional monomers are vinyl ethers and include VEctomer® 4010, which is a vinyl ether terminated aromatic ester monomer having a chemical formula of C₂₀H₂₆O₆ and a chemical name of bis-(4-vinyloxybutyl) isophthalate; Vectomer® 4051, which is a vinyl ether terminated cycloaliphatic aromatic ester monomer having a chemical formula of C₂₈H₃₈O₆ and a chemical name of bis [[[4-(ethenyloxy)methyl]cyclohexyl]methyl] terephthalate; VEctomer® 4060, which is a vinyl ether terminated aliphatic ester monomer having a chemical formula of C₁₈H₃₀O₆ and a chemical name of bis-(4-vinyloxybutyl) adipate; VEctomer® 4230, which is a vinyl ether terminated aliphatic urethane monomer having a chemical formula of C₂₀H₃₆N₂O₆ and a chemical name of bis-(4-vinyloxybutyl)hexamethylenediurethane; and Vectomer® 5015, which is a vinyl ether terminated aromatic ester monomer having a chemical formula of C₂₇H₃₆O₉ and a chemical name of tris(4-vinyloxybutyl)trimellitate. The Vectomer® products are available from Morflex Inc. (Greensboro, N.C.). The Rapi-Cure® multifunctional monomers are vinyl ethers, such as 4-hydroxybutylvinylether (RAPI-CURE® HBVE), triethyleneglycol divinylether (RAPI-CURE® DVE-3), and cyclohexane dimethanolvinylether (RAPI-CURE® CHVE) and are available from International Specialty Products (Wayne, N.J.). Additional examples of acrylate monomers include those sold under the Ebecryl® tradename, which are available from Surface Specialties, and those sold under the Actilane® tradename, which are available from Akzo Nobel Resins (Bergen op Zoom, the Netherlands).

The photoinitiator in the coating formulation may initiate polymerization of the multifunctional monomer to form the barrier layer. The photoinitiator may be activated by exposure to UV radiation, such as radiation having a wavelength ranging from approximately 100 nm to approximately 400 nm. For instance, the photoinitiator may be activated by UV radiation ranging from approximately 280 nm to approximately 400 nm. The photoinitiator may be a cationic photoinitiator or a free radical photoinitiator depending on the type of multifunctional monomer that is used in the coating formulation. Upon exposure to the UV radiation, the photoinitiator may produce cations or free radicals, which initiate polymerization of the multifunctional monomer if the multifunctional monomer includes acrylate or methacrylate groups, the photoinitiator may be the free radical photoinitiator. If the multifunctional monomer includes vinyl, epoxide, or oxetane groups, the cationic photoinitiator may be used. During photolysis, many cationic photoinitiators generate free radicals in addition to the cations. Therefore, a cationic photoinitiator may be used to initiate polymerization if the multifunctional monomer includes a mixture of acrylate or methacrylate groups and vinyl, epoxide, or oxetane groups.

Examples of free radical photoinitiators include, but are not limited to: acyloin; a derivative of acyloin, such as benzoin, benzoin methyl ether benzoin ethyl ether, benzoin isopropyl ether, benzoin isobutyl ether, desyl bromide, and α-methylbenzoin; a diketone, such as benzil and diacetyl; an organic sulfide, such as diphenyl monosulfide, diphenyl disulfide, desyl phenyl sulfide, and tetramethylthiuram monosulfide; a thioxanthone; an S-acyl dithiocarbamate, such as S-benzoyl-N,N-dimethyldithiocarbamate and S-(p-chlorobenzoyl)-N,N-dimethyldithiocarbamate; a phenone, such as acetophenone, α,α,α-tribromoacetophenone, o-nitro-α,α,α-tribromoacetophenone, benzophenone, and p,p′-tetramethyldiaminobenzophenone; a quinone; a triazole; a sulfonyl halide, such as p-toluenesulfonyl chloride; a phosphorus-containing photoinitiator, such as an acylphosphine oxide; an acrylated amine; or mixtures thereof.

The cationic photoinitiator may be an onium salt, such as a sulfonium salt, an iodonium salt, or mixtures thereof. The cationic photoinitiatior may be a bis-diaryliodonium salt, a diaryliodonium salt of sulfonic acid, a triarylsulfonium salt of sulfonic acid, a diaryliodonium salt of boric acid, a diaryliodonium salt of boronic acid, a triarylsulfonium salt of boric acid, a triarylsulfonium salt of boronic acid, or mixtures thereof. Examples of cationic photoinitiatiors include, but are not limited to, diaryliodonium hexafluoroantimonate, aryl sulfonium hexafluorophosphate, aryl sulfonium hexafluoroantimonate, bis(dodecyl phenyl) iodonium hexafluoroarsenate, tolyl-cumyliodonium tetrakis(pentafluorophenyl) borate, bis(dodecylphenyl) iodonium hexafluoroantimonate, dialkylphenyl iodonium hexafluoroantimonate, diaryliodonium salts of perfluoroalkylsulfonic acids (such as diaryliodonium salts of perfluorobutanesulfonic acid, perfluoroethanesulfonic acid, perfluorooctanesulfonic acid, and trifluoromethane sulfonic acid), diaryliodonium salts of aryl sulfonic acids (such as diaryliodonium salts of para-toluene sulfonic acid, dodecylbenzene sulfonic acid, benzene sulfonic acid, and 3-nitrobenzene sulfonic acid), triarylsulfonium salts of perfluoroalkylsulfonic acids (such as triarylsulfonium salts of perfluorobutanesulfonic acid, perfluoroethanesulfonic acid, perfluorooctanesulfonic acid, and trifluoromethane sulfonic acid), triarylsulfonium salts of aryl sulfonic acids (such as triarylsulfonium salts of para-toluene sulfonic acid, dodecylbenzene sulfonic acid, benzene sulfonic acid, and 3-nitrobenzene-sulfonic-acid), diaryliodonium salts of perhaloarylboronic acids, triarylsulfonium salts of perhaloarylboronic acid, or mixtures thereof.

The photoinitiator may be present in the coating formulation in an amount sufficient to initiate curing of the multifunctional monomer, such as in an amount of up to approximately 10 wt %. For instance, the photoinitiator may be present in a range from approximately 0.1 wt % to approximately 10 wt %.

Depending on the desired properties of the barrier layer, the coating formulation may optionally include at least one additive, such as a slip aid, a flow aid, a cure accelerator, an inhibitor, a defoaming agent, a UV light stabilizer, a UV light absorber, a surfactant, or an optical brightener. However, in one embodiment, the coating formulation is substantially free of these additional, optional additives.

To change or tailor the viscosity of the coating formulation of the barrier layer, the coating formulation may include a small amount of at least one oligomer in place of a small amount of the multifunctional monomer. The oligomer may be present in the coating formulation in an amount ranging from approximately 5 wt % to approximately 10 wt %. For the sake of example only, the oligomer may be an acrylate oligomer, such as that sold under the Roskydal® tradename, which is available from Bayer Corp. (Pittsburgh, Pa.).

To form the coating formulation of the barrier layer, the multifunctional monomer, the photoinitiator, and any optional ingredients that may be present, may be mixed or blended together as known in the art. Since the multifunctional monomer is a liquid at room temperature, the photoinitiator may be dissolved in the multifunctional monomer. As such, the coating formulation of the barrier layer may have a high solids content, such as greater than approximately 95 wt % solids content. In one embodiment, the coating formulation of the barrier layer includes approximately 100% solids. Since the coating formulation has a high solids content and does not include water, the coating formulation is neat. Therefore, no drying may be necessary before curing the coating formulation to form the barrier layer. Furthermore, since the coating formulation is neat, no byproducts are produced that need to be disposed of. However, to aid in processing, small amounts of water may be present in the coating formulation. For instance the water may be present in the coating formulation at from approximately 0 wt % to approximately 20 wt %. A surfactant may also optionally be used in the coating formulation to aid in processing.

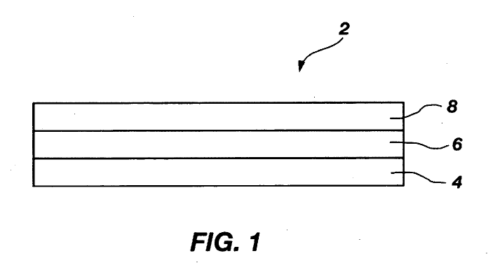

To form the print medium 2, the coating formulation of the barrier layer may be applied to at least one surface of a substrate 4, as shown in FIG. 1. The substrate 4 may be a transparent, opaque, or translucent material, such as a hard or flexible material made from a polymer, a paper, a glass, a ceramic, a woven cloth, a non-woven cloth, or a metal material. For instance, the substrate 4 may be a paperbase or a photobase. The paperbase may be an uncoated plain paper or a plain paper having a porous coating, such as a calendared paper, an uncalendared paper, a cast-coated paper, a clay coated paper, or a commercial offset paper. The photobase may be a paper that is coated by coextrusion with a high- or low-density polyethylene, polypropylene, or polyester on both surfaces of the paper. In one embodiment, the substrate 4 is a paperbase. The substrate 4 may have a thickness ranging from approximately 5 μm to approximately 1000 μm depending on a desired end application for the print medium 2.

The substrate 4 may optionally include at least one additive, such as a paper sizing agent, a dry paper strengthening agent, a wet paper strengthening agent, a filler, a fixing agent, a pH adjusting agent, or an electroconductive agent. These additives are known in the art and, therefore, are not described in detail herein. The substrate 4 may optionally be pretreated with adhesion promoters, as known in the art, to increase adhesion between the barrier layer 6 and the substrate 4. The adhesion promoter may be a polymer or copolymer having an acid functionality. The substrate 4 may also be pretreated by anchor coating, corona discharge, irradiation, or plasma before the barrier layer 6 is formed on the substrate 4. Alternatively, an intermediate layer may be formed between the barrier layer 6 and the substrate 4 to increase the adhesion.

The coating formulation of the barrier layer may be applied to the substrate 4 by conventional techniques, such as by spraying, dipping, or coating. The coating techniques may include, but are not limited to, direct coating, wire bar coating, blade coating, dampner coating, curtain coating, gravure coating, air-knife coating, extrusion coating, and roll coating. To reduce its viscosity, the coating formulation of the barrier layer may be heated before applying the coating formulation to the substrate 4.

The coating formulation may then be cured to form the barrier layer 6, which is in substantial contact with the substrate 4. While FIG. 1 shows that the barrier layer 6 is formed on one surface of the substrate 4, it is understood that the barrier layer 6 may also be formed on both surfaces of the substrate 4. The coating formulation of the barrier layer may be cured by exposing the coating formulation to a radiation source that emits UV radiation of an appropriate wavelength to activate the photoinitiator. The radiation source may be a commercially available radiation source, such as a sun lamp, a mercury lamp or a mercury arc, a metal halide lamp, an exymer lamp, a UV laser, a light emitting diode (“LED”), a carbon arc, a tungsten filament lamp, a xenon arc, or a krypton arc. The radiation source may emit a wavelength of radiation that ranges from approximately 100 nm to approximately 400 nm, such as from approximately 280 nm to approximately 400 nm. The radiation source may be used in combination with reflectors to focus or diffuse the UV radiation and a cooling system to remove heat generated by the radiation source.

The coating formulation of the barrier layer may be exposed to the UV radiation for a sufficient amount of time to polymerize the multifunctional monomer and to provide the desired mechanical properties, flexibility, and moisture barrier properties to the print medium 2. The amount of time used to cure the coating formulation may depend on the radiation source used and a coating weight of the coating formulation. The coating formulation of the barrier layer may be substantially cured after exposure to the UV radiation for from approximately 0.1 second to approximately 120 seconds at room temperature. As such, the coating formulation may be quickly cured to form the barrier layer 6. If the coating formulation is cured for an amount of time that is too short to substantially cure the multifunctional monomer, the barrier layer 6 may be tacky and may not prevent water from diffusing into the substrate 4. Conversely, if the coating formulation is cured for an amount of time that is too long, the barrier layer 6 may be stiff and brittle or the substrate 4 may become degraded.

The barrier layer 6 may have a coating weight of at least 2 grams per square meter (“GSM”). For instance, the barrier layer 6 may have a coating weight ranging from approximately 2 GSM to approximately 30 GSM.

After curing the barrier layer 6, an ink-receiving layer 8 may be formed on the barrier layer 6. The ink-receiving layer 8 may be in substantial contact with the barrier layer 6. The ink-receiving layer 8 may be a conventional ink-receiving layer, such as a porous ink-receiving layer or a swellable ink-receiving layer. The ink-receiving layer 8 may include any type of ink-receiving layer so long as the ink-receiving layer 8 is sufficiently adherent to the barrier layer 6. The ink-receiving layer 8 may be capable of receiving an aqueous-based inkjet ink. The ink-receiving layer 8 may include a polymeric binder and solid particulates. Polymeric binders for use in the ink-receiving layer 8 may include, but are not limited to, polyvinyl alcohols, modified polyvinyl alcohols, polyvinyl pyrrolidone, vinyl pyrrolidone copolymers, polyethylene oxide, polyethylene glycol, starch, modified starch, cellulose, cellulose derivatives, polyacrylic acids, alginates, water-soluble gums, dextrans, carrageenan, a latex emulsion binder, xanthan, chitin, proteins, gelatins, agar, and mixtures thereof. The solid particles may be inorganic or organic particles including, but not limited to, calcium carbonate, calcium sulfate, silica, alumina, alumina hydroxide, aluminum silicate, calcium silicate, magnesium silicate, zinc oxide, zinc sulfate, zinc carbonate, titanium dioxide, beomite, zeolite, styrene pigments, acrylic pigments, polyethylene, urea, and melamine. The ink-receiving layer 8 may optionally include at least one additive, such as a surfactant, a preservative, an antioxidant, a penetrating agent, or a UV absorber. These additives are known in the art and, therefore, are not described in detail herein. The ink-receiving layer 8 may also be a UV-curable ink-receiving layer.

To form the ink-receiving layer 8, a coating formulation of the ink-receiving layer may be prepared by conventional techniques, such as by mixing the ingredients of the ink receiving layer. The coating formulation of the ink-receiving layer may then be applied to the barrier layer 6 by conventional coating techniques, such as by the coating techniques previously described in forming the barrier layer 6. To enhance adhesion of the ink-receiving layer 8 to the barrier layer 6, the cured barrier layer 6 may be treated before applying the ink-receiving layer 8. For instance, the barrier layer 6 may be pretreated by anchor coating, corona discharge, irradiation, or plasma before forming the ink-receiving layer 8 on the barrier layer 6.

To print a desired image on the print medium 2, the inkjet ink may be applied to the ink-receiving layer 8. The inkjet ink may include a colorant, such as a dye or pigment, dissolved or dispersed in an ink vehicle that includes water and water-soluble or water-miscible organic solvents. Inkjet inks are known in the art and, therefore, the inkjet ink is not described in detail herein. The inkjet ink may optionally include at least one additive, such as a surfactant, a corrosion inhibitor, a pH adjusting agent, or a biocide (anti-microbial agent, anti-fungal agent, etc.) depending on the desired properties of the inkjet ink. These additives are known in the art and, therefore, are not discussed in detail herein. The inkjet ink may be applied to the print medium 2 using an inkjet printer. The inkjet printer may be a conventional black and white or color inkjet printer, such as a DeskJet® printer available from Hewlett-Packard Co. (Palo Alto, Calif.).

To determine whether the barrier layer 6 provides the desired moisture barrier properties, the inkjet ink may be applied to the print medium 2 as known in the art. After applying the inkjet ink, the print medium 2 may be observed to determine whether the inkjet ink has penetrated the barrier layer 6. For instance, the print medium 2 may be monitored at predetermined time intervals, such as periodically over the course of a few months, to determine whether the inkjet ink has undesirably passed through the barrier layer 6 and penetrated into the substrate 4.

The barrier layer 6 may prevent moisture, in the form of water or organic solvents present in the inkjet ink, from penetrating the substrate 4. As such, the barrier layer 6 may reduce or eliminate cockling or swelling of the substrate 4, which helps to retain surface gloss of the image printed on the print medium 2. In addition, the barrier layer 6 may prevent fibers of the substrate 4 from being disturbed, providing smoothness and gloss to the printed image. The barrier layer 6 may also provide support to the substrate 4. The image printed on the print medium 2 may have a high surface gloss, good optical density, and good color gamut.

The following are examples of coating formulations of the barrier layer for use within the scope of the present invention. These examples are merely illustrative and are not meant to limit the scope of the present invention in any way.

### EXAMPLES

### Example 1

A Coating Formulation of the Barrier Layer Including a Diacrylate

A coating formulation of the barrier layer having 97 wt % PEG 600 diacrylate and 3 wt % of a free radical photoinitiator was prepared. The coating formulation was applied to a paperbase and cured to form the barrier layer.

### Example 2

### A Coating Formulation of the Barrier Layer Including HDODA

A coating formulation of the barrier layer having 97 wt % HDODA and 3 wt % of a photoinitiator was prepared. The coating formulation was applied to a paperbase and cured to form the barrier layer.

### Example 3

### A Coating Formulation of the Barrier Layer Including a Vinyl Ether

A coating formulation of the barrier layer having 97 wt % VEctomer® 4010 and 3 wt % of a cationic photoinitiator is prepared. The coating formulation is applied to a paperbase and cured to form the barrier layer.

### Example 4

### A Coating Formulation of the Barrier Layer Including HDODA and HBVE

A coating formulation of the barrier layer having 67 wt % HDODA, 30 wt % Rapi-Cure® HBVE, and 3 wt % of a photoinitiator is prepared. The coating formulation is applied to a paperbase and cured to form the barrier layer.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. An ultraviolet-curable coating formulation that consists essentially of at least one multifunctional monomer and a photoinitiator.

2. The ultraviolet-curable coating formulation of claim 1, wherein the at least one multifunctional monomer comprises at least one of a difunctional monomer, a trifunctional monomer, a tetrafunctional monomer, a pentafunctional monomer, a hexafunctional monomer, and mixtures thereof.

3. The ultraviolet-curable coating formulation of claim 1, wherein the at least one multifunctional monomer comprises at least one monomer selected from the group consisting of a urethane monomer, a polyester monomer, an acrylate monomer, a polyester acrylate monomer, a polyether monomer, an acrylic ester monomer, a vinyl ether monomer, a urethane acrylate, a polyepoxide monomer, an N-vinyl pyrrolidone monomer, a caprolactam monomer, and mixtures thereof.

4. The ultraviolet-curable coating formulation of claim 1, wherein the at least one multifunctional monomer comprises at least one vinyl ether monomer selected from the group consisting of 4-hydroxybutylvinyl ether, triethyleneglycol divinyl ether, cyclohexane dimethanolvinyl ether, bis-(4-vinyloxybutyl)isophthalate, bis [[[4-(ethenyloxy)methyl]cyclohexyl]methyl] terephthalate, bis-(4-vinyloxybutyl)adipate, bis-(4-vinyloxybutyl) hexamethylenediurethane, tris(4-vinyloxybutyl)trimellitate, and mixtures thereof.

5. The ultraviolet-curable coating formulation of claim 1, wherein the at least one multifunctional monomer comprises at least one acrylate monomer selected from the group consisting of dipropylene glycol diacrylate, 1,6-hexanediol diacrylate, ethoxylated hydroxydioxanediacrylate, tripropylene glycol diacrylate, polyethylene glycol diacrylate, a triethylene glycol diacrylate, a bisphenol-A derivative diacrylate monomer, an acrylated dipentaerythritol, a propoxylated glycol triacrylate, pentaerythritol triacrylate, trimethylolpropane ethoxy triacrylate, trimethylolpropane triacrylate, tetraethylene glycol dimethacrylate-4-ethylene glycol, trimethylolpropane trimethacrylate, octyl/decyl acrylate, isobornyl acrylate, and mixtures thereof.

6. The ultraviolet-curable coating formulation of claim 1, wherein the at least one multifunctional monomer comprises a mixture of at least one acrylate monomer and at least one vinyl ether monomer.

7. The ultraviolet-curable coating formulation of claim 1, wherein the at least one multifunctional monomer is present in the ultraviolet-curable coating formulation from approximately 80% by weight to approximately 99.9% by weight.

8. The ultraviolet-curable coating formulation of claim 1, wherein the photoinitiator comprises a free radical photoinitiator selected from the group consisting of acyloin, benzoin, benzoin methyl ether, benzoin ethyl ether, benzoin isopropyl ether, benzoin isobutyl ether, desyl bromide, α-methylbenzoin, diphenyl monosulfide, diphenyl disulfide, desyl phenyl sulfide, tetramethylthiuram monosulfide, a thioxanthone, S-benzoyl-N,N-dimethyldithiocarbamate, S-(p-chlorobenzoyl)-N,N-dimethyldithiocarbamate, acetophenone, α,α,α-tribromoacetophenone, o-nitro-α,α,α-tribromoacetophenone, benzophenone, p,p′-tetramethyldiaminobenzophenone, a quinone, a triazole, p-toluenesulfonyl chloride, an acylphosphine oxide, an acrylated amine, and mixtures thereof.

9. The ultraviolet-curable coating formulation of claim 1, wherein the photoinitiator comprises a cationic photoinitiator selected from the group consisting of diaryliodonium hexafluoroantimonate, aryl sulfonium hexafluorophosphate, aryl sulfonium hexafluoroantimonate, bis(dodecyl phenyl) iodonium hexafluoroarsenate, tolyl-cumyliodonium tetrakis(pentafluorophenyl) borate, bis(dodecylphenyl) iodonium hexafluoroantimonate, dialkylphenyl iodonium hexafluoroantimonate, a diaryliodonium salt of perfluorobutanesulfonic acid, a diaryliodonium salt of perfluoroethanesulfonic acid, a diaryliodonium salt of perfluorooctanesulfonic acid, a diaryliodonium salt of trifluoromethane sulfonic acid, a diaryliodonium salt of para-toluene sulfonic acid, a diaryliodonium salt of dodecylbenzene sulfonic acid, a diaryliodonium salt of benzene sulfonic acid, a diaryliodonium salt of 3-nitrobenzene sulfonic acid, a triarylsulfonium salt of perfluorobutanesulfonic acid, a triarylsulfonium salt of perfluoroethanesulfonic acid, a triarylsulfonium salt of perfluorooctanesulfonic acid, a triarylsulfonium salt of trifluoromethane sulfonic acid, a triarylsulfonium salt of para-toluene sulfonic acid, a triarylsulfonium salt of dodecylbenzene sulfonic acid, a triarylsulfonium salt of benzene sulfonic acid, a triarylsulfonium salt of 3-nitrobenzene sulfonic acid, a diaryliodonium salt of perhaloarylboronic acid, a triarylsulfonium salt of perhaloarylboronic acid, and mixtures thereof.

10. The ultraviolet-curable coating formulation of claim 1, wherein the ultraviolet-curable coating formulation has a solids content of greater than approximately 95% by weight.

11. A print medium for use in inkjet printing, comprising:
a substrate;
a barrier layer formed from a coating formulation that consists essentially of at least one multifunctional monomer and a photoinitiator; and
an ink-receiving layer.

12. The print medium of claim 11, wherein the substrate comprises a paperbase or a photobase.

13. The print medium of claim 11, wherein the at least one multifunctional monomer comprises at least one of a difunctional monomer, a trifunctional monomer, a tetrafunctional monomer, a pentafunctional monomer, a hexafunctional monomer, and mixtures thereof.

14. The print medium of claim 11, wherein the at least one multifunctional monomer comprises at least one monomer selected from the group consisting of a urethane monomer, a polyester monomer, an acrylate monomer, a polyester acrylate monomer, a polyether monomer, an acrylic ester monomer, a vinyl ether monomer, a urethane acrylate, a polyepoxide monomer, an N-vinyl pyrrolidone monomer, a caprolactam monomer, and mixtures thereof.

15. The print medium of claim 11, wherein the at least one multifunctional monomer comprises at least one vinyl ether monomer selected from the group consisting of 4-hydroxybutylvinyl ether, triethyleneglycol divinyl ether, cyclohexane dimethanolvinyl ether, bis-(4-vinyloxybutyl)isophthalate, bis [[[4-(ethenyloxy)methyl]cyclohexyl]methyl] terephthalate, bis-(4-vinyloxybutyl)adipate, bis-(4-vinyloxybutyl) hexamethylenediurethane, tris(4-vinyloxybutyl)trimellitate, and mixtures thereof.

16. The print medium of claim 11, wherein the at least one multifunctional monomer comprises at least one acrylate monomer selected from the group consisting of dipropylene glycol diacrylate, 1,6-hexanediol diacrylate, ethoxylated hydroxydioxanediacrylate, tripropylene glycol diacrylate, polyethylene glycol diacrylate, a triethylene glycol diacrylate, a bisphenol-A derivative diacrylate monomer, an acrylated dipentaerythritol, a propoxylated glycol triacrylate, pentaerythritol triacrylate, trimethylolpropane ethoxy triacrylate, trimethylolpropane triacrylate, tetraethylene glycol dimethacrylate-4-ethylene glycol, trimethylolpropane trimethacrylate, octyl/decyl acrylate, isobornyl acrylate, and mixtures thereof.

17. The print medium of claim 11, wherein the at least one multifunctional monomer comprises a mixture of at least one acrylate monomer and at least one vinyl ether monomer.

18. The print medium of claim 11, wherein the at least one multifunctional monomer is present in the coating formulation from approximately 80% by weight to approximately 99.9% by weight.

19. The print medium of claim 11, wherein the photoinitiator comprises a free radical photoinitiator selected from the group consisting of acyloin, benzoin, benzoin methyl ether, benzoin ethyl ether, benzoin isopropyl ether, benzoin isobutyl ether, desyl bromide, α-methylbenzoin, diphenyl monosulfide, diphenyl disulfide, desyl phenyl sulfide, tetramethylthiuram monosulfide, a thioxanthone, S-benzoyl-N,N-dimethyldithiocarbamate, S-(p-chlorobenzoyl)-N,N-dimethyldithiocarbamate, acetophenone, α,α,α-tribromoacetophenone, o-nitro-α,α,α-tribromoacetophenone, benzophenone, p,p′-tetramethyldiaminobenzophenone, a quinone, a triazole, p-toluenesulfonyl chloride, an acylphosphine oxide, an acrylated amine, and mixtures thereof.

20. The print medium of claim 11, wherein the photoinitiator comprises a cationic photoinitiator selected from the group consisting of diaryliodonium hexafluoroantimonate, aryl sulfonium hexafluorophosphate, aryl sulfonium hexafluoroantimonate, bis(dodecyl phenyl) iodonium hexafluoroarsenate, tolyl-cumyliodonium tetrakis(pentafluorophenyl) borate, bis(dodecylphenyl) iodonium hexafluoroantimonate, dialkylphenyl iodonium hexafluoroantimonate, a diaryliodonium salt of perfluorobutanesulfonic acid, a diaryliodonium salt of perfluoroethanesulfonic acid, a diaryliodonium salt of perfluorooctanesulfonic acid, a diaryliodonium salt of trifluoromethane sulfonic acid, a diaryliodonium salt of para-toluene sulfonic acid, a diaryliodonium salt of dodecylbenzene sulfonic acid, a diaryliodonium salt of benzene sulfonic acid, a diaryliodonium salt of 3-nitrobenzene sulfonic acid, a triarylsulfonium salt of perfluorobutanesulfonic acid, a triarylsulfonium salt of perfluoroethanesulfonic acid, a triarylsulfonium salt of perfluorooctanesulfonic acid, a triarylsulfonium salt of trifluoromethane sulfonic acid, a triarylsulfonium salt of para-toluene sulfonic acid, a triarylsulfonium salt of dodecylbenzene sulfonic acid, a triarylsulfonium salt of benzene sulfonic acid, a triarylsulfonium salt of 3-nitrobenzene sulfonic acid, a diaryliodonium salt of perhaloarylboronic acid, a triarylsulfonium salt of perhaloarylboronic acid, and mixtures thereof.

21. The print medium of claim 11, wherein the coating formulation has a solids content of greater than approximately 95% by weight.

22. A method of forming a print medium, comprising:
providing a coating formulation that consists essentially of at least one multifunctional monomer and a photoinitiator;
applying the coating formulation to a substrate;
curing the coating formulation to form a barrier layer; and
forming an ink-receiving layer on the barrier layer.

23. The method of claim 22, wherein providing the coating formulation that consists essentially of the at least one multifunctional monomer and the photoinitiator comprises selecting the at least one multifunctional monomer from at least one of a difunctional monomer, a trifunctional monomer, a tetrafunctional monomer, a pentafunctional monomer, a hexafunctional monomer, and mixtures thereof.

24. The method of claim 22, wherein providing the coating formulation that consists essentially of the at least one multifunctional monomer and the photoinitiator comprises selecting the at least one multifunctional monomer selected from the group consisting of a urethane monomer, a polyester monomer, an acrylate monomer, a polyester acrylate monomer, a polyether monomer, an acrylic ester monomer, a vinyl ether monomer, a urethane acrylate, a polyepoxide monomer, an N-vinyl pyrrolidone monomer, a caprolactam monomer, and mixtures thereof.

25. The method of claim 22, wherein providing the coating formulation that consists essentially of the at least one multifunctional monomer and the photoinitiator comprises selecting the at least one multifunctional monomer selected from the group consisting of 4-hydroxybutylvinyl ether, triethyleneglycol divinyl ether, cyclohexane dimethanolvinyl ether, bis-(4-vinyloxybutyl)isophthalate, bis [[[4-(ethenyloxy)methyl]cyclohexyl]methyl] terephthalate, bis-(4-vinyloxybutyl)adipate, bis-(4-vinyloxybutyl) hexamethylenediurethane, tris(4-vinyloxybutyl)trimellitate, and mixtures thereof.

26. The method of claim 22, wherein providing the coating formulation that consists essentially of the at least one multifunctional monomer and the photoinitiator comprises selecting an acrylate monomer selected from the group consisting of dipropylene glycol diacrylate, 1,6-hexanediol diacrylate, ethoxylated hydroxydioxanediacrylate, tripropylene glycol diacrylate, polyethylene glycol diacrylate, a triethylene glycol diacrylate, a bisphenol-A derivative diacrylate monomer, an acrylated dipentaerythritol, a propoxylated glycol triacrylate, pentaerythritol triacrylate, trimethylolpropane ethoxy triacrylate, trimethylolpropane triacrylate, tetraethylene glycol dimethacrylate-4-ethylene glycol, trimethylolpropane trimethacrylate, octyl/decyl acrylate, isobornyl acrylate, and mixtures thereof.

27. The method of claim 22, wherein providing the coating formulation that consists essentially of the at least one multifunctional monomer and the photoinitiator comprises selecting the at least one multifunctional monomer to include a mixture of at least one acrylate monomer and at least one vinyl ether monomer.

28. The method of claim 22, wherein providing the coating formulation that consists essentially of the at least one multifunctional monomer and the photoinitiator comprises providing the coating formulation that consists essentially of from approximately 80% by weight to approximately 99.9% by weight of the at least one multifunctional monomer.

29. The method of claim 22, wherein providing the coating formulation that consists essentially of the at least one multifunctional monomer and the photoinitiator comprises selecting a free radical photoinitiator selected from the group consisting of acyloin, benzoin, benzoin methyl ether, benzoin ethyl ether, benzoin isopropyl ether, benzoin isobutyl ether, desyl bromide, α-methylbenzoin, diphenyl monosulfide, diphenyl disulfide, desyl phenyl sulfide, tetramethylthiuram monosulfide, a thioxanthone, S-benzoyl-N,N-dimethyldithiocarbamate, S-(p-chlorobenzoyl)-N,N-dimethyldithiocarbamate, acetophenone, α,α,α-tribromoacetophenone, o-nitro-α,α,α-tribromoacetophenone, benzophenone, p,p′-tetramethyldiaminobenzophenone, a quinone, a triazole, p-toluenesulfonyl chloride, an acylphosphine oxide, an acrylated amine, and mixtures thereof.

30. The method of claim 22, wherein providing the coating formulation that consists essentially of the at least one multifunctional monomer and the photoinitiator comprises selecting a cationic photoinitiator selected from the group consisting of diaryliodonium hexafluoroantimonate, aryl sulfonium hexafluorophosphate, aryl sulfonium hexafluoroantimonate, bis(dodecyl phenyl) iodonium hexafluoroarsenate, tolyl-cumyliodonium tetrakis(pentafluorophenyl) borate, bis(dodecylphenyl) iodonium hexafluoroantimonate, dialkylphenyl iodonium hexafluoroantimonate, a diaryliodonium salt of perfluorobutanesulfonic acid, a diaryliodonium salt of perfluoroethanesulfonic acid, a diaryliodonium salt of perfluorooctanesulfonic acid, a diaryliodonium salt of trifluoromethane sulfonic acid, a diaryliodonium salt of para-toluene sulfonic acid, a diaryliodonium salt of dodecylbenzene sulfonic acid, a diaryliodonium salt of benzene sulfonic acid, a diaryliodonium salt of 3-nitrobenzene sulfonic acid, a triarylsulfonium salt of perfluorobutanesulfonic acid, a triarylsulfonium salt of perfluoroethanesulfonic acid, a triarylsulfonium salt of perfluorooctanesulfonic acid, a triarylsulfonium salt of trifluoromethane sulfonic acid, a triarylsulfonium salt of para-toluene sulfonic acid, a triarylsulfonium salt of dodecylbenzene sulfonic acid, a triarylsulfonium salt of benzene sulfonic acid, a triarylsulfonium salt of 3-nitrobenzene sulfonic acid, a diaryliodonium salt of perhaloarylboronic acid, a triarylsulfonium salt of perhaloarylboronic acid, and mixtures thereof.

31. The method of claim 22, wherein providing the coating formulation that consists essentially of the at least one multifunctional monomer and the photoinitiator comprises formulating the coating formulation to have a solids content of greater than approximately 95% by weight.

32. The method of claim 22, wherein curing the coating formulation to form the barrier layer comprises exposing the coating formulation to radiation having a wavelength ranging from approximately 280 nm to approximately 400 nm.
